(19) United States
(12) Patent Application Publication
(10) Pub. No.: US 2007/0082094 A1
(43) Pub. Date: Apr. 12, 2007

(54) Coated food compositions and related methods of preparation

(76) Inventors: David Julian McClements, Northampton, MA (US); Eric Andrew Decker, Sunderland, MA (US); Jochen Weiss, South Hadley, MA (US)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 11/529,044

(22) Filed: Sep. 28, 2006

Related U.S. Application Data
(60) Provisional application No. 60/721,280, filed on Sep. 28, 2005.

(51) Int. Cl. A23L 1/00

(52) U.S. Cl. 426/302

(57) ABSTRACT

Coated food compositions and related methods as can be used to provide protection and stability against degradation.

This invention claims priority benefit from application Ser. No. 60/721,280 filed Sep. 28, 2005, the entirety of which is incorporated herein by reference.

The United States Government has certain rights to this invention pursuant to Grant No. 2002-35503-12296 from the Department of Agriculture to the University of Massachusetts.

### BACKGROUND OF THE INVENTION

Food producers, processors, retailers and others in the food supply and distribution chain have long been concerned about maintaining product quality. Shipping, storage and shelf-life each contribute to an eventual degradation process and overall loss of nutritional value. Loss of discarded or unsaleable food items can be calculated into the billions of dollars, contributing to increased overall consumer cost.

Various techniques have been developed to maintain quality; however, each has associated with it one or more issues of concern relative to a particular producer, processor and/or consumer. For instance, numerous anti-oxidant and stabilizing ingredients are utilized, but are perceived to have attendant health and safety concerns. Likewise, various coating materials have been devised, but can present certain application, dimension and/or uniformity concerns. Further, if unedible or perceived to be unnatural, such coatings or their removal can reduce demand and eventual sale.

### SUMMARY OF THE INVENTION

In light of the foregoing, it is an object of the present invention to provide multicomponent coated food compositions and methods for production, thereby overcoming various deficiencies and shortcomings of the prior art, including those discussed above. It will be understood by those skilled in the art that one or more aspects of this invention can meet certain objectives, while one or more aspects can meet certain other objectives. Each objective may not apply equally, in all its respects, to every aspect of this invention. As such, the following objects can be viewed in the alternative with respect to any one aspect of this invention.

It is an object of the present invention to provide a molecular- or colloidal-based approach to coating compositions, using in certain embodiments edible food-grade components.

It is a related object of this invention to utilize such a molecular or colloidal approach to facilitate application control.

It is another object of this invention to selectively design a coating composition from one or more molecular- or colloidal-based components to maintain one or more quality criteria.

It can be another object of this invention to provide a range of food compositions comprising a nano- (or micro-) dimensioned, multicomponent coating thereabout, such coatings edible without comprising food quality, taste or nutrition.

Other objects, features, benefits and advantages of the present invention will be apparent from this summary and the following descriptions of certain embodiments, and will be readily apparent to those skilled in art having knowledge of food-grade emulsifiers, and particulate polymeric components and related food compositions and products and associated production techniques. Such objects, features, benefits and advantages will be apparent from the above as taken into conjunction with the accompanying examples, data, figures and all reasonable inferences to be drawn there from, alone or with consideration of the references incorporated herein.

Accordingly, the present invention can be directed to the preparation or application of various coating components, on or about a particular food component, such application more controllable as compared to use of conventional technologies. In particular, by choice of component composition, coating dimension, and the number and/or order of various coating components, it is possible to control the rheology, permeability, stability and other coating parameters. In addition, such methods provide opportunity to engineer or incorporate into such coatings unique functional attributes afforded by anti-microbials, anti-browning, anti-oxidants, enzymes and other such active agents known in the art.

In part, this invention can provide a method for protective coating and/or preparation of a food article or composition comprising a multicomponent coating on or thereabout. Broadly, the methods of this invention can utilize an interactive affinity of a coating component with a food component substrate and/or another component applied thereto or associated therewith. For example, one or a plurality of coating components can be coupled, applied or adsorbed to the surface of a food component substrate or another previously-applied/adsorbed coating material, and used to degradatively-stabilize the substrate such interactive affinity depending upon the physical or chemical nature of the substrate surface and/or coating material. Such interactions will be apparent from those skilled in the art made aware of this invention and can, without limitation, be selected from electrostatic, hydrogen bonding and hydrophobic/hydrophilic interactions and van der Waals interactions. Accordingly, also without limitation, such a protective method can comprise providing a food component substrate; contacting the food component with one of a food-grade polymeric component, a food-grade emulsifier component and/or a food-grade particulate component, at least a portion of which has a net charge; and contacting or incorporating therewith one or more food-grade emulsifier component, polymeric component, and/or particulate component at least a portion of each comprising a net charge opposite that of the component previously incorporated or contacted or contacted.

Alternatively, a functional or active particulate component can be contacted or incorporated with one or more of the aforementioned emulsifier and/or polymeric components or introduced thereto as a part of an emulsion. For instance, an aqueous emulsion of an oil, fat or hydrophobic material (e.g., without limitation, a flavor oil, an anti-oxidant, an anti-microbial, etc.) can be contacted with a previously-applied emulsifier or polymeric component or, optionally, dried to provide a corresponding particulate material, then reconstituted for use as a part of a multicomponent coating composition. See, e.g., co-pending applications entitled “Encapsulated Emulsions and Methods of Preparation,” and “Stabilized Antimicrobial Compositions and Related Methods of Preparation”, each filed contemporaneously herewith and incorporated herein by reference in its entirety. Regardless, as demonstrated elsewhere herein, such emulsifier, polymeric and particulate components can be edible, can function according to choice or combination and perform well in the context of a particular food composition.

Accordingly, in certain embodiments, such a method can comprise alternating contact or incorporation of oppositely charged emulsifier and food-grade polymeric components, each such contact or incorporation comprising electrostatic interaction with a previously contacted or incorporated emulsifier or polymeric component. Alternatively, in accordance with broader aspects of this invention, other coating components can be contacted with a food component substrate and successively applied thereto via other physical or chemical interactions including, but not limited to, hydrogen bonding and affinities originating from various hydrophilic/hydrophobic interactions.

In part, this invention can also comprise an alternate method for layer formation. With reference to the preceding, a polymeric, emulsifier or particulate component can be contacted with the other or a food component under conditions or at a pH not conducive for sufficient electrostatic interaction therewith. The pH can then be varied to change the net electrical charge of the substrate or coating sufficient to promote electrostatic interaction with and incorporation of the polymeric, emulsifier or particulate component. Without limitation, a food substrate can be contacted with a protein (e.g., without limitation casein, whey, soy, egg or gelatin) at a pH below its isoelectric point, to form cationic or net positively-charged coating or film, with subsequent application of an anionic or net negatively-charged polysaccharide (e.g., without limitation, pectin, carrageenan, alginate, or gum arabic) coating for electrostatic interaction with the initial coating/film.

Food products or components of this invention include, but are not limited to, animal and plant produce and components thereof, whether raw or processed, such produce including, but not limited to, whole fruits and vegetables, fruit and vegetable pieces, herbs, spices, nuts and grains. In certain other embodiments, the food components of this invention can include processed food products, such as but not limited to pastas, cereals, bakery goods, candies, frozen food items, canned goods, confectionaries and meat products.

An emulsifier component can comprise any food-grade surface active ingredient, cationic surfactant, anionic surfactant and/or amphiphilic surfactant known to those skilled in the art capable of at least adsorbing, electrostatically interacting and/or coupling to a food component or a polymeric component thereon. In certain embodiments, an emulsifier can contact a food component substrate or a polymeric component on or about a substrate, imparting a net charge to at least a portion thereof. The emulsifier component can include small-molecule surfactants, fatty acids, phospholipids, proteins and polysaccharides. Such emulsifiers can further include one or more of, but not limited to, lecithin, chitosan, modified starches, pectin, gums (e.g., locust bean gum, gum arabic, guar gum, etc.), alginic acids, alginates and derivatives thereof, and cellulose and derivatives thereof. Protein emulsifiers can include any one of the dairy proteins (e.g., whey and casein), vegetable proteins (e.g., soy), meat proteins, fish proteins, plant proteins, ovalbumins, glycoproteins, mucoproteins, phosphoproteins, serum albumins, collagen and combinations thereof. Protein emulsifying components can be selected on the basis of their amino acid residues (e.g., lysine, arginine, asparatic acid, glutamic acid, etc.) to optimize the overall net charge of the coating.

Indeed, the emulsifier component can include a broad spectrum of emulsifiers including, for example, acetic acid esters of monogylcerides (ACTEM), lactic acid esters of monogylcerides (LACTEM), citric acid esters of monogylcerides (CITREM), diacetyl acid esters of monogylcerides (DATEM), succinic acid esters of monogylcerides, polyglycerol polyricinoleate, sorbitan esters of fatty acids, propylene glycol esters of fatty acids, sucrose esters of fatty acids, mono and diglycerides, fruit acid esters, stearoyl lactylates, polysorbates, starches, sodium dodecyl sulfate (SDS) and/or combinations thereof. Various other emulsifier components and possible colloidal assemblies can include those discussed below in conjunction with certain embodiments, e.g., micelles, bilayers, vesicles.

As discussed above, a polymeric component can comprise any food-grade polymeric material capable of adsorption, electrostatic interaction and/or coupling to a food component and/or an associated emulsifier component. Accordingly, the food-grade polymeric component can be a biopolymer material selected from, but not limited to, proteins (e.g., whey, casein, soy, egg, plant, meat and fish proteins), ionic or ionizable polysaccharides such as chitosan and/or chitosan sulfate, cellulose, pectins, alginates, nucleic acids, glycogen, amylose, chitin, polynucleotides, gum arabic, gum acacia, carageenans, xanthan, agar, guar gum, gellan gum, tragacanth gum, karaya gum, locust bean gum, lignin and/or combinations thereof. As mentioned above, such protein components can be selected on the basis of their amino acid residues to optimize overall net charge, interaction with an emulsifier component and/or resultant coating stability. The food-grade polymeric component may alternatively be selected from modified polymers such as modified starch, carboxymethyl cellulose, carboxymethyl dextran or lignin sulfonates. Other polymeric components useful in conjunction with this invention are discussed below.

The present invention contemplates any combination of emulsifier, particulate and/or polymeric components leading to the formation of a multi-layered coating or film sufficiently stable under environmental or end-use conditions applicable to a particular food component. Accordingly, a food component can be wholly or partially encapsulated and/or coated with a wide range of emulsifiers/polymeric/particulate components, depending upon the pH, ionic strength, salt concentration, temperature and processing requirements. Such emulsifier/polymeric/particulate component combinations are limited only by interaction one with another and formation of a corresponding multicomponent coating composition. Such emulsifier/polymeric/particulate components can be selected from those described or inferred in co-pending application Ser. No. 11/078,216 filed Mar. 11, 2005, the entirety of which is incorporated herein by reference.

In accordance with the preceding, a particulate component can, without limitation, be adsorbable on a food component surface, emulsifier or polymer, be hydrophobic or at least partially insoluble in an aqueous medium and/or can be emulsified in an aqueous medium. In certain embodiments, the particulate component can comprise a fat or an oil component, including but not limited to, any edible food oil known to those skilled in the art (e.g., corn, soybean, canola, rapeseed, olive, peanut, algal, nut and/or vegetable oils, fish oils or a combination thereof). The particulate component can be selected from hydrogenated or partially hydrogenated fats and/or oils, and can include any dairy or animal fat or oil including, for example, dairy fats. The particulate component can further comprise flavors, anti-oxidants, preservatives and/or nutritional components, such as fat soluble vitamins, any of which in an amount at least partially sufficient for desired functional effect (e.g., without limitation degradative stability). Various other particulate components include but are not limited to those provided below, in conjunction with certain embodiments of this invention.

It will be readily apparent that, consistent with the broader aspects of the invention, the particulate component can further include any natural and/or synthetic lipid components including, but not limited to, fatty acids (saturated or unsaturated), glycerols, glycerides and their respective derivatives, phospholipids and their respective derivatives, glycolipids, phytosterol and/or sterol esters (e.g., cholesterol esters, phytosterol esters and derivatives thereof), carotenoids, terpenes, anti-oxidants, colorants, and/or flavor oils (for example, peppermint, citrus, coconut, or vanilla and extracts thereof such as terpenes from citrus oils), as may be required by a given food or end use application. Other such components include, without limitation, brominated vegetable oils, ester gums, sucrose acetate isobutyrate, damar gum and the like. The present invention, therefore, contemplates a wide range of edible oil/fat, waxes and/or lipid components of varying molecular weight and comprising a range of hydrocarbon (aromatic, saturated or unsaturated), alcohol, aldehyde, ketone, acid and/or amine moieties or functional groups.

Without limitation, coated food components can be prepared using food-grade emulsifier, particulate and/or polymeric components and standard preparation procedures (e.g., homogenization and mixing). Initially, a primary coating comprising a net electrically charged emulsifier component can be applied to a food component by contact (e.g., dipping or spraying) with an emulsifier medium. Optionally, rinsing or washing can be used to remove any non-incorporated emulsifier component. A secondary coating can be prepared by contacting a polymeric or particulate component, in an appropriate medium, with the primary coating. The polymeric component can have a net electrical charge opposite to at least a portion of the primary coating. Optionally, rinsing or washing can remove non-incorporated polymeric component. As discussed above, emulsion characteristics can be altered by pH adjustment to promote or enhance electrostatic interaction between any particular emulsifier and polymeric components.

Accordingly, this invention can also relate, at least in part, to a food article or composition comprising a food component substrate, an emulsifier component and a polymeric component. Consistent with the broader aspects of this invention, such a composition can comprise a plurality of component layers of any food-grade material on or about a food component substrate, each layer comprising an interactive affinity (e.g., without limitation, a net charge opposite) with that of at least a portion of an adjacent or previously-applied material. Alternatively, a particulate emulsion or suspension can be applied in conjunction with an emulsifier or polymeric component, or dried then reconstituted for subsequent application.

### BRIEF DESCRIPTION OF THE DRAWINGS

FIG. 1. A non-limiting schematic representation of a method, in accordance with this invention, for preparation of a food composition comprising a multicomponent coating thereabout, such a method optionally employing successive dipping and washing procedures. Each dipping solution can contain a component capable of absorbing to the surface of a food component substrate or a previously-applied coating component.

FIG. 2. Non-limiting schematic representations of various emulsifier, polymeric, particulate, emulsion and colloid components as can be used, in accordance with this invention, on food component substrates in the preparation of multicomponent coatings and corresponding food compositions.

FIG. 3. With reference to FIGS. 1 and 2, a schematic illustration of one non-limiting multicomponent coating composition on a food component substrate.

FIG. 4. Turbidity versus pH profiles for alginate-carrageenan plates in contact with whey protein-coated droplets at different pH values.

FIG. 5. Digital images of the surfaces of alginate-carrageenan plates that had been brought into contact with casein-coated protein droplets at different pH values.

### BRIEF DESCRIPTION OF CERTAIN EMBODIMENTS

As described elsewhere herein, this invention can be directed to coated food compositions and methods for preparation. The present emulsifier and/or polymeric components can, in certain embodiments, comprise food-grade components, as can be processed economically using current production technologies, without further testing or regulatory approval. Further, as described more fully in one or more of the incorporated references, such emulsifiers and polymeric components can also be used to enhance the stability of a food component to degradation (e.g., oxidation, etc).

For instance, a multiple-stage process could be used to coat a food component with two or three component layers (e.g., emulsifier-biopolymer 1-(optionally) biopolymer 2). First, a primary coating or film can be prepared by contacting a food component with an aqueous phase comprising an ionic or amphiphilic emulsifier. If necessary, rinsing or washing could be carried out to remove any non-adsorbed emulsifier. Second, a coating comprising emulsifier-biopolymer 1 multicomponent composition can be formed by contacting biopolymer 1 with the primary coating. Biopolymer 1 can have a net electrical charge opposite that of the net charge of at least a portion of the primary coating. If necessary, mechanical agitation or sonication can be applied to the secondary coating to disrupt any flocs formed, and washing could be used to remove any non-adsorbed biopolymer. Third, a tertiary coating comprising emulsifier-biopolymer 1-biopolymer 2 multicomponent composition can be formed by contacting biopolymer 2 and the secondary coating. Biopolymer 2 can have a net electrical charge opposite the net charge of at least a portion of the secondary coating. If necessary, rinsing or washing could be carried out to remove any non-adsorbed biopolymer. This procedure can be continued to add more components to the coating composition.

For example, coatings comprising tri-layer coated produce or a food product can be prepared using food-grade ingredients (e.g., lecithin, chitosan, pectin) and standard preparation procedures (homogenization, mixing). Initially, a primary composition comprising an anionic coating can be produced by dipping the produce into an aqueous bath of lecithin. A secondary composition containing a cationic coating can be produced by contacting a chitosan solution with the primary composition, and applying mechanical agitation to disrupt any flocs formed. A tertiary composition containing another anionic coating can then be produced by contacting a pectin solution with the secondary composition.

As described herein, a food composition can be prepared by successively contacting a food component with one or more emulsifier and/or polymeric components. The compositions are stable under end-use conditions, whereby the emulsifier and/or polymeric components can be selected based on the temperature, pH, salt concentration, and ionic strength appropriate for the processing and end-use application of a particular food component. Moreover, there exists a wide range of component choice for each layer component about the food component, thereby permitting selection of component materials that do not alter the nutritional, physicochemical or sensory properties of the coated food substrate and permitting such compositions to be readily used without adverse effect on food component taste, appearance, texture or stability.

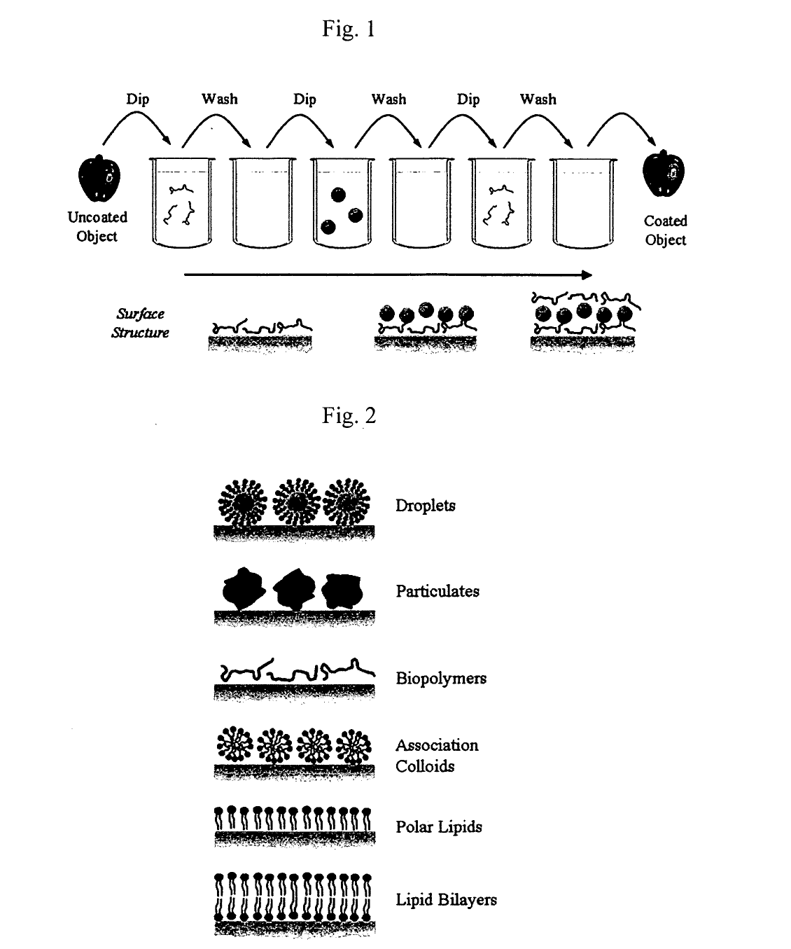

For example, by way of illustration, an object to be coated can be dipped into a series of solutions containing components that would adsorb to the surface of the object (FIG. 1). (Alternatively the solutions containing the adsorbing components could be sprayed onto the surface of the object.) Between each dipping step, a washing and/or drying step can remove the excess solution attached to the surface prior to introduction of the object in the next dipping solution. The composition, thickness, structure and properties of the multicomponent coating formed around the object can be controlled in a number of ways, including: (i) changing the type of adsorbing components in the dipping solutions; (ii) changing the total number of dipping steps used; (iii) changing the order that the object is introduced into the various dipping solutions; (iv) changing the solution and environmental conditions used, such as pH, ionic strength, dielectric constant, temperature, etc.

As schematically shown in FIG. 2, a variety of different adsorbable components and combinations thereof can be used to create multiple coating layers. With reference to the preceding:
Biopolymers. Any food-grade biopolymer material that is capable of adsorbing to the exposed surface on the object could be used, such as proteins (e.g., whey, casein, soy, egg, plant, meat, fish proteins or enzymes), polysaccharides (e.g., pectin, chitosan, starch, modified starch, cellulose, modified cellulose, gum arabic, alginates, guar gum, xanthan, gums, carrageenans, agars, seed gums, tree gum exudates, gellan gum), and combinations thereof.
Surface Active Lipids. Any food-grade surface-active lipid that is capable of adsorbing to the exposed surface on the object, e.g., phospholipids (lecithin), small molecule surfactants (Tweens, Polysorbates, Spans, SLS, DATEM, CITREM), fatty acids, and combinations therefore. These surface active lipids could form single layers, bi-layers, multiple layers, micelles, vesicles or other association colloids at the surface. (See, e.g., FIG. 2.)
Emulsion Droplets. Any food-grade emulsion droplet that is capable of adsorbing to the exposed surface on the object. The emulsion droplet can comprise a liquid oil droplet coated by a food-grade emulsifier, but it could also be a partly or fully crystallized oil droplet, or an oil droplet containing water droplets.
Particulate Matter. Any food-grade particle that is capable of adsorbing to the exposed surface on the object could be used, such as a mustard particle, herb, spice, egg granule, fat crystal, air bubble, biological cell etc.

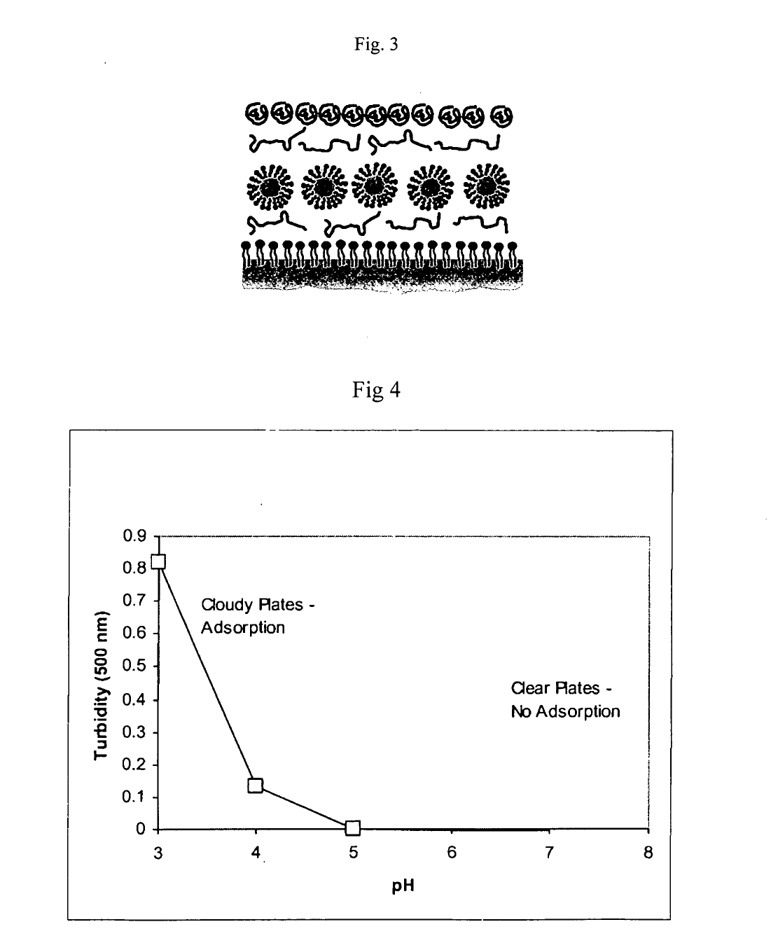

The choice of the type of adsorbing component(s) used to create each coating layer, the total number of layers incorporated into the overall coating/film, the sequence of the different layers, and the preparation conditions used to prepare each layer will determine the function of the resulting multicomponent compositions, e.g., their permeability (e.g., to gasses, organic substances, minerals or water), rheology (e.g., their rigidity, flexibility, brittleness), swelling and wetting characteristics. In addition, the methods of this invention can enable encapsulation of various hydrophilic, amphiphilic or lipophilic particulates within the films, e.g., by incorporating them in association with colloidal structures such as micelles or vesicles. Thus, it is possible to incorporate active functional agents such as anti-microbials, anti-browning agents, anti-oxidants, enzymes, etc. into the coatings, to increase the shelf-life and quality of the food component. An illustration of one such multicomponent coating composition (on or about a food component substrate) is shown in FIG. 3.

Regardless of the method of preparation, an emulsion of particulate components can be contacted with a wall material selected from polar lipids, proteins and/or carbohydrates. Various wall materials will be known to those skilled in the art and made aware of this invention. Such emulsions, together with one or more wall component materials can be used as a feed material from a spray dryer. Accordingly, a corresponding emulsion can be processed into a dispersion of droplets comprising a wall component about a particulate, e.g., emulsified oil/fat components. The dispersion can be introduced to and contacted with a hot drying medium to promote at least partial evaporation of the aqueous phase from the dispersion droplets, providing solid or solid-like particles comprising oil/fat, emulsifier and polymeric compositions within a wall component matrix. Where applicable, the emulsion can be reconstituted for application (e.g., dip-coated onto a food component substrate or a previously-applied component) in conjunction with a multicomponent coating composition of the sort described herein. (See, e.g., FIGS. 2 and 3.)

### EXAMPLES OF THE INVENTION

The following non-limiting examples and data illustrate various aspects and features relating to the articles, compositions and/or methods of the present invention, including the assembly of various food coating compositions as are available through the methodologies described herein. In comparison with the prior art, the present methods, compositions and/or articles provide results and data which are surprising, unexpected and contrary thereto. While the utility of this invention is illustrated through the use of several compositions and molecular components which can be used therewith, it will be understood by those skilled in the art, that comparable results are obtainable with various other compositions, components, coatings and/or layers as are commensurate with the scope of this invention.

### Example 1

Formation of multilayer coatings is demonstrated by adsorbing representative positively-charged protein-coated droplets to an agar-carrageenan surface, a representative anionic biopolymer. Such a procedure and the resulting composite/article would be understood by those skilled in the art as indicative of and demonstrating various methods, compositions and articles of this invention.

An agar (3 wt %), carrageenan (0.5 wt %) and water (96.5 wt %) mixture (20 mL) is poured into a transparent plate and left to form a gel.

A 10 wt % corn oil-in-water emulsion of small lipid droplets coated by protein (0.5 wt % whey protein isolate or 1 wt % sodium caesinate) is formed using a blender and/or high pressure valve homogenizer. Emulsions of pH 3, 4, 5, 6, 7 and 8 were prepared. In some cases 1% Sudan III was added to the corn oil as a dye to facilitate observation of the emlusions by microscopy.

The emulsions (5 mL) were poured onto the biopolymer-coated plates for 5 minutes, then poured off. The plates were then washed with a buffer solution of an appropriate pH to remove any non-adsorbed lipid droplets.

### Example 2

The influence of pH on the adsorption of protein-coated lipid droplets to the biopolymer-coated plates was observed by optical microscopy and by measuring the turbidity (at 500 nm) of the plates using UV-visible spectrophotometry.

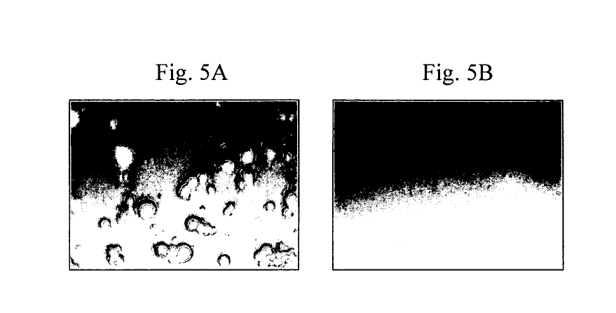

There was clear evidence of the formation of a droplet layer on the biopolymer coated surfaces (FIG. 4). At pH 3 and 4, the plates were turbid because of adsorption of positively charged protein-coated droplets to the negatively charged biopolymer-coated plates. At higher pH values (where the electrical charges are more similar), the plates were clear indicating that no adsorption of the protein-coated droplets occurred. Optical microscopy also indicated that adsorption of droplets occurred at low pH values (FIG. 5A and FIG. 5B). Adsorption clearly occurs more so at pH 3.2 (where the electrical charges on the protein-coated droplets and the alginate-carrageenan surfaces are opposite) than at pH 8.1 (where the electrical charges are similar).

While the principles of this invention have been described in connection with specific embodiments, it should be understood clearly that these descriptions are added only by way of example and are not intended to limit, in any way, the scope of this invention. For instance, the present invention can be applied more specifically to the preparation of multicomponent coatings on a variety of pharmaceutical, chemical, health care and personal care components.

We claim:

1. A method of protective food coating, said method comprising:
providing food component substrate; and
contacting at least a portion of said substrate with at least one of a polymeric component, an emulsifier component, a particulate component and combinations thereof, each said component capable of interactive affinity with at least one of said substrate and another said component.

2. The method of claim 1 wherein one said interactive affinity comprises electrostatic interaction.

3. The method of claim 2 comprising adjusting pH of at least one of said substrate, polymeric component, emulsifier component, and particulate component, said adjustment sufficient to change net charge on at least a portion thereof.

4. The method of claim 2 wherein said contact comprising successive application of one said polymeric component and one said emulsifier component to said substrate.

5. The method of claim 4 wherein at a portion of said polymeric component has a net charge and at least a portion of said emulsifier component has a net charge opposite said polymeric component.

6. The method of claim 5 comprising adjusting pH of at least one of said substrate, polymeric component and emulsifier component, said adjustment sufficient to change net charge on at least a portion thereof.

7. The method of claim 5 wherein said emulsifier component is selected from lecithin, chitosan, pectin, locust bean gum, gum arabic, guar gum, alginic acids, alginates, cellulose, modified cellulose, modified starch, whey proteins, caseins, soy proteins, fish proteins, meat proteins, plant proteins, polysorbates, fatty acid salts, small molecule surfactants and combinations thereof.

8. The method of claim 7 wherein said emulsifier component comprises a particulate component selected from oils, fats, anti-oxidants, anti-microbials, enzymes and combinations thereof.

9. The method of claim 5 wherein said polymeric component is selected from proteins, polysaccharides and combinations thereof.

10. The method of claim 1 wherein said substrate is selected from fruits, vegetables, meats, nuts, grains and food products prepared therefrom.

11. A method of using a coating component to stabilize a food substrate, said method comprising:
providing a food substrate component; and
contacting said substrate with at least one coating component selected from a polymeric component and an emulsifier component, said coating component comprising at least one functional particulate component present in an amount at least partially sufficient to degradatively-stabilize said substrate.

12. The method of claim 11 wherein said functional particulate is selected from oils, fats, anti-oxidants, anti-microbials, vitamins, preservatives, enzymes and combinations thereof.

13. The method of claim 12 wherein said functional particulate is emulsified.

14. The method of claim 13 wherein said emulsion is reconstituted from a spray-dried emulsion.

15. The method of claim 13 wherein said emulsifier component is selected from lecithin, chitosan, pectin, locust bean gum, gum arabic, guar gum, alginic acids, alginates, cellulose, modified cellulose, modified starch, whey proteins, caseins, soy proteins, fish proteins, meat proteins, plant proteins, polysorbates, fatty acid salts, small molecule surfactants; and said polymeric component is selected from proteins, polysaccharides and combinations thereof.

16. A degradatively-stabilized food article comprising a food component substrate: and at least one of a polymeric component, and emulsion component and a particulate component, said component coupled to at least a portion of said substrate, each said component capable of electrostatic interaction with at least one of said substrate and another said component.

17. The article of claim 16 comprising a polymeric component and an emulsifier component coupled to said substrate, wherein at least a portion of said polymeric component has a net charge and at least portion of said emulsifier component has a net charge opposite said polymeric net charge.

18. The article of claim 17 wherein said emulsifier component comprises at least one of lecithin, chitosan, pectin, locust bean gum, gum arabic, guar gum, alginic acids, alginates, cellulose, modified cellulose, modified starch, whey proteins, caseins, soy proteins, fish proteins, meat proteins, plant proteins, polysorbates, fatty acid salts, small molecule surfactants.

19. The article of claim 18 wherein said emulsifier component comprises at least one functional particulate present in an amount at least partially sufficient to degradatively-stabilize said substrate.

20. The article of claim 17 wherein said polymeric component is selected from proteins, polysaccharides and combinations thereof.
